(19) United States
(12) Patent Application Publication
(10) Pub. No.: US 2024/0280458 A1
(43) Pub. Date: Aug. 22, 2024

(54) DEVICE AND METHOD FOR ANALYZING A GASEOUS SAMPLE, AND RAMAN SPECTROMETER

(71) Applicant: Hilti Aktiengesellschaft, Schaan (LI)

(72) Inventor: Stefan KRÄMER, Ilmenau (DE)

(21) Appl. No.: 18/567,118

(22) PCT Filed: Jun. 27, 2022
(86) PCT No.: PCT/EP2022/067501

§ 371 Date: Dec. 5, 2023

(30) Foreign Application Priority Data
Jul. 9, 2021 (EP) 21184638.1

(51) Int. Cl. G01N 15/0205; G01N 1/24; G01N 1/40

(52) U.S. Cl. CPC G01N 15/0205; G01N 1/24; G01N 1/4077; G01N 2001/245; G01N 2001/4088

(57) ABSTRACT

A device for analyzing a gaseous sample in respect of a composition of the particles contained in the sample, the device including the following components: a device for sucking in the gaseous sample, a device for separating the particles contained in the gaseous sample on the basis of a diameter of the particles, a device for collecting the particles, a sensor device for analyzing the particles contained in the gaseous sample and a device for evaluating spectra. The sensor device operates on the basis of Raman scattering and is configured to produce the spectra to be evaluated. In particular, the evaluation can be implemented by way of a comparison of the produced spectra with reference spectra, with these reference spectra possibly describing different forms of existence of silicon dioxide in particular. A method for analyzing a gaseous sample in respect of a composition of the particles contained in the sample, and to a Raman spectrometer which may be a constituent part of the proposed device.

The invention relates to a device for analyzing a gaseous sample in respect of a composition of the particles contained in the sample. In further aspects, the invention relates to a method for analyzing a gaseous sample in respect of a composition of the particles contained in the sample, and to a Raman spectrometer.

### BACKGROUND OF THE INVENTION

A focus of the construction industry in recent years has related to the health protection of workers. In this context, a number of regulations and provisions were enacted in order to better protect workers on construction sites from detriments to health, which may occur when working in the construction industry. A focus of these regulations was directed at dust protection at work, and protection from the substances classified as risky or hazardous to health contained therein. Quartz is such a potentially hazardous substance. The quartz content in a dust to be measured represents important information because quartz is associated with diseases such as silicosis or lung cancer. Since in many countries increasing efforts are being made to protect workers in mining or on construction sites better than before from high levels of dust exposure and the accompanying negative health effects, there is great interest in practicable, realistic and cost-effective technical solutions for examining dust. Experts would particularly welcome it if a possible way in which a quartz content in a dust to be measured can be determined quickly and reliably could be created, in order to be able to take suitable protective measures for the workers concerned.

### SUMMARY OF THE INVENTION

It would therefore be desirable for it to be possible to provide a device as a “dust dosimeter”, which the workers can carry with them on a construction site and which determines the amount of quartz to which the construction worker is exposed in the course of the day.

However, the prior art has not disclosed any satisfactory solutions that allow such a “live measurement” of the fine quartz dust content in the ambient air to be carried out, that is to say by means of which the fine quartz dust content in the ambient air is able to be monitored continuously. Instead, particle sensors as known from U.S. Pat. No. 8,009,290 B1 and DE 20 2019 102 221 U1 are used to examine the ambient air. However, such particle sensors are frequently unable to distinguish the detected particles in terms of substance. Expressed differently, the use of the known particle sensors often does not allow a decision to be made in respect of which material, which chemical substance or element or which chemical compound should be assigned to a group of particles. On account of this lack of evaluation possibilities, it is not possible either to make statements about the risks to health that the particles contained in the ambient air pose.

The prior art has disclosed that detected particles can be sorted and distinguished according to their geometric diameter, that is to say their “size”. However, this analysis is afflicted by the structural error that it is not the geometric diameter of a particle that is the relevant variable for health protection, but the so-called aerodynamic diameter. The aerodynamic diameter within the meaning of the invention is defined as the diameter of a substantially spherical particle with a density of 1 g/cm³, which has substantially the same settling velocity as a particle to be considered. By way of example, if an aerodynamic diameter of 10 μm is classified as hazardous in a legislative text or in the text of a regulation, then particles with a geometric diameter of approximately 4 μm and less are hazardous for quartz with a density of approximately 2.5 g/cm³. Such a conversion can also be carried out using the data determined by conventional particle sensors. However, it was found that the analysis of air sample data sets represents a technical challenge on account of their complex composition and the required calibrations.

Moreover, conventional particle sensors as known from the prior art often cannot be integrated in body-worn devices because small, manageable body-worn equipment often does not have sufficient space for the components of such sensors that are required to measure and analyze the ambient air sample.

The prior art has disclosed laboratory measuring equipment or constituent parts of such structures, for example as described in US 2020 0009 560 A1. However, this laboratory measuring equipment frequently also does not facilitate a live measurement and evaluation of data sets, and so the user does not obtain instant feedback regarding their current dust exposure. Moreover, known laboratory measuring equipment is often expensive, complicated and difficult to operate, and so it can only be operated by trained staff. However, this practically precludes operation “in the field”, that is to say on a construction site, for example. Moreover, the known equipment from the prior art often lacks the robustness vis-à-vis tremors, dirtying, etc., that is required to be able to survive daily use, for example on a construction site.

A further disadvantage of the measuring devices for examining particles in the ambient air, known from the prior art, is that these are usually unable to recognize, or distinguish between, silicon dioxide and its various crystal modifications such as quartz, cristobalite or tridymite, and amorphous silicon dioxide. Such a distinction is relevant, in particular, because the various crystal modifications of silicon dioxide and the amorphous silicon dioxide are classified differently in terms of their potential hazard to health.

It is an object of the present invention to overcome the above-described defects and disadvantages of the prior art and to specify a device and a method for analyzing a gaseous sample, which facilitate live measurements within the meaning of continuous monitoring of a user. The device to be specified should be designed to be so robust that it can be used in rough surroundings, for example on a construction site. Moreover, the device to be provided should be easy to operate so that laypeople can use it and understand its displays or displayed results. In particular, the aerodynamic diameter of particles, which is relevant to health protection, should be able to be examined and evaluated using the device to be specified and the method to be specified. Experts would further appreciate if the measuring device to be provided were able to reliably distinguish between silicon dioxide, its various crystal modifications and amorphous silicon dioxide. Moreover, it would be desirable for the device to be provided to be able to be integrated in a body-worn device.

In a first aspect, the present invention provides a device for analyzing a gaseous sample in respect of a composition of the particles contained in the sample, the device comprising the following components:
a) a device for sucking in the gaseous sample,
b) a device for separating the particles contained in the gaseous sample on the basis of a diameter of the particles,
c) a device for collecting the particles,
d) a sensor device for analyzing the particles contained in the gaseous sample on the basis of the diameter of the particles, the sensor device operating on the basis of Raman scattering and being configured to produce spectra,
e) a device for evaluating the spectra by virtue of the spectra being compared with reference spectra by means of the device for evaluation purposes.

The device is advantageously configured to measure a fine quartz dust content in a gaseous sample, the gaseous sample in particular being able to comprise the respiratory air of a user of the device. Within the meaning of the invention, the term “gaseous” preferably means that this relates to a gaseous sample, for example air, with this sample being able to contain various particles. By way of example, this may relate to quartz, dust or other contamination in the ambient air, for example as occurs on construction sites. The purpose of the measuring device consists of analyzing the particles contained in a gaseous sample in respect of their composition, that is to say of determining the composition. This should allow the user to better assess the health burden emanating from the particles. In particular, this is achieved by virtue of the user knowing the composition of the particles in the ambient air or in their respiratory air and being able to behave or react accordingly, and being able to take up countermeasures. Within the meaning of the invention, it is preferable for the gaseous sample to also be referred to as “gas or air sample”.

In the spectra, the radiation intensity or radiant power is preferably plotted against the wavelength. Since the wavelength of the Raman scattering depends on the excitation wavelength, it is preferable within the meaning of the invention to convert the wavelength into a shift, which is preferably also referred to as Raman shift within the meaning of the invention. This advantageously simplifies a comparison of a spectra recorded using different excitation wavelengths.

According to the invention, provision is made for the device to at least comprise the following components: a device for sucking in the gaseous sample, a device for separating the particles contained in the gaseous sample on the basis of a diameter of the particles, a device for collecting the particles, a sensor device for analyzing the particles contained in the gaseous sample and a device for evaluating spectra. In this case, the device for sucking in the gaseous sample is preferably referred to as a “sucking-in device” within the meaning of the invention, while the device for separating the particles is preferably referred to as a “separation device”. The device for collecting the particles can also be used to capture the particles and is preferably referred to as a “collection device” or “capture device” within the meaning of this invention. The device for evaluating the spectra is preferably also referred to as an “evaluation device”.

A substantial advantage of the invention consists in the fact that the device may be in the form of a body-worn measuring device which—similar to a radiation dosimeter—can be carried along or worn by a user, or can be fastened to a piece of apparel. The inventor has recognized that using a sensor device operating on the basis of Raman scattering allows the provision of manageable, compact equipment which can be carried along by a user at work, for example on a construction site, and which can be used as a “dust dosimeter”. In an alternative embodiment of the invention, the device may be present arranged on an air cleaning device, for example, and may be line-connected to the air cleaning device. By way of example, information, data and/or control components may be exchanged between the device and the air cleaning device, without being limited thereto. By way of example, the connection can be a wired connection, in the case of which data are exchanged via cables or other lines, for example. However, wireless communication may also be provided between the air cleaning device and the device. Moreover, contacts may be provided in order to facilitate communication or data exchange between the items of equipment. By way of example, the ambient air of the air cleaning device can be examined using the proposed device and an activation command can be transmitted from the device to the air cleaning device in order to activate said air cleaning device if significant contamination of the ambient air is determined. The presence of significant contamination of the ambient air of the air cleaning device may be determined, for example, by thresholds stored in the air cleaning device and/or in the device being exceeded. In particular, the air cleaning device can be activated by the proposed device when the proportion of quartz in the ambient air exceeds a specified threshold. The air cleaning device can also be deactivated by means of the proposed device should corresponding limits in relation to the air contamination, in particular in respect of the modifications of silicon dioxide, be undershot.

The sensor device which operates on the basis of Raman scattering is preferably also referred to as “Raman sensor” or “Raman spectrometer” within the meaning of the invention. In this respect, the invention relates in particular to a measuring device for analyzing a gaseous sample, comprising a Raman spectrometer.

The apparatus is preferably based on the fact that a molecule can be excited by incident, monochromatic light to carry out dipole vibrations, with the dipole thus becoming a secondary radiation source. The dipole vibration can be modulated by resonant frequencies of the molecule in the crystal lattice so that further peaks arise in the spectrum, these peaks are known as Stokes lines and anti-Stokes lines. In the context of the present invention, the Raman scattering is well suited to the analysis of, and making a distinction between, crystalline substances as a result of this modulation. Tests have shown that especially the quartz modifications of interest in the context of this invention can be recognized particularly well using Raman scattering and can be distinguished from other substances. Moreover, the wavelength to be examined depends on the excitation. The components of the device are preferably chosen such that the peaks to be expected in the spectrum can easily be found using a combination according to the invention of a light source and sensor.

In particular, the device facilitates the implementation of live measurements of the dust exposure of a user of the device and a live analysis of the composition of the particles contained in the ambient air. Within the meaning of the invention, the term “composition of the particles” preferably means that the number of particles contained in a gaseous sample can be examined in respect of their composition. Consequently, this preferably does not relate to the material composition of a single, relatively large particle but instead relates to the specification of the components of different particle types that make up the overall particle amount in the gaseous sample. Advantageously, the invention is even able to determine and output the components of the individual crystal modifications of silicon dioxide, and of amorphous silicon dioxide. In particular, this is facilitated by virtue of the reference spectra, to which the spectra determined by the sensor devices are compared, describing the various aforementioned forms of silicon dioxide.

Within the meaning of the invention, it is preferable for the device for sucking in the gaseous sample to be a fan or a pump. Preferably, the device for sucking in the gaseous sample is configured to convey a gas volume of 8-10 l/min. Tests have shown that an optimal evaluation of the particle composition in a gaseous sample containing particles to be analyzed can be facilitated with this volume of air per unit time. In particular, it was found that it is possible to provide sufficient gas for an optimal evaluation of the sample by way of the aforementioned amount of gas or air per unit time. Then again, the amount of gas per unit time is not too large either so that it is necessary to take account of changing collection or deposition efficiencies during the analysis and evaluation of the particle composition. Such deviations need to be taken into account in particular when more larger particles and hence more inert particles are inhaled by comparison. In particular, this may be the case with relatively large gas volumes.

It is particularly preferred within the meaning of the invention for the device to be present arranged on a user or their surroundings so that the gaseous sample is taken from the respiratory air of the user. Within the meaning of the invention, the term “respiratory air of the user” preferably describes the volume of gas present in the region of the nose and the mouth of the user, which is able to be inhaled by the user through the nose or through the mouth. This arrangement in spatial proximity of the face of the user renders a particularly accurate and realistic analysis of the particle composition possible because the user will with a very high probability inhale gas from the gas volume denoted “respiratory air”. By way of example, the device can be worn in the region of the user's chest. To this end, the device can be put into a chest pocket of a pair of work trousers or a shirt or a jacket, for example. Preferably, the device may comprise fastening means, by means of which the device can be fastened to the apparel of the user.

It is preferable within the meaning of the invention for the device for separating the particles to be configured to separate the particles according to their aerodynamic diameter. In this preferred embodiment of the invention, the separation device can be in the form of an inertial separator. A cyclone separator is an example of an inertial separator. By using a separation device which can sort or detect the particles to be analyzed according to the aerodynamic diameter, it is possible to obtain an analysis of the particle composition that is particularly meaningful for protecting the user's health by means of the invention because the harm potential of a substance or particle material arises from its aerodynamic diameter in particular.

Inertial separators are preferably characterized in that particles which are contained in the air to be cleaned or examined are, on account of their inertia, unable to follow a pronounced change in direction or a pronounced change in the flow speed that is produced by the separator. By way of example, the flow movement can be caused by a rotation in a cyclone or a bend in a flow path. Since the inertia of the particles is substantially proportional to the mass and the flow acts on the surface of the particles there is a separation of the particles according to their aerodynamic diameter.

In an alternative embodiment of the invention, it may also be preferable for the device for separating the particles to be configured to separate the particles according to their geometric diameter. In this preferred embodiment of the invention, the separation device can be in the form of a filter. The provision of a separation device in the form of a filter can provide a cost-effective device in particular, which lends itself in particular to large-scale use with many users. By way of example, such devices with separation devices that distinguish the particles to be analyzed according to their geometric diameter may be used if substantially all workers on a large construction site, for example in the case of airports, office buildings or football stadiums, are equipped with a proposed device.

Within the meaning of the invention, it is preferable for the device for collecting the particles to be in the form of a filter. Preferably, the particles contained in the gaseous sample are deposited on the collection or capture device such that the particles or their composition can subsequently be evaluated and/or analyzed by the sensor device. By way of example, the particles to be analyzed can be deposited on the surface or in the interior of the collection device. It is preferable within the meaning of the invention for the filter or the filter material to have a pore size that is chosen to be small enough so as not to lose any particles relevant to the examination. Then again, the filter surface is selected so sufficiently large within the context of the invention that the pump can deliver a sufficiently high volumetric flow rate. By way of example, the pore size can be chosen to correspond to the resolution of the image sensor. To carry out the spectrometry, the filter material is preferably selected in such a way that a surface that is as homogeneous as possible is formed. The surface preferably has no resonances in the range relevant to the quartz modifications so as not to impair the measurements. By way of example, nitrocellulose can be used as filter material.

It is preferable within the meaning of the invention for the sensor device for analyzing the particles to be arranged above or below the device for collecting the particles. Expressed differently, the sensor device may be present arranged above or below the collection or capture device within the proposed measuring device. The arrangement of the sensor device is in particular chosen in such a way that sharp, optical imaging of the surface of the collection or capture device is rendered possible. As a result, the filter surface or the occupation thereof by different particles can be analyzed or examined using optical processes.

It is preferable within the meaning of the invention for the sensor device for analyzing the particles to be arranged at a distance d from the device for collecting the particles, the distance d being in a range from 1 to 50 mm, preferably in a range from 2 to 20 mm. Tests have shown that the preferred spaced apart arrangement of sensor device and collection or capture device firstly permits the deposition of the particles from the gaseous sample on the capture device. Moreover, it was found that the aforementioned distances d ranging from 0.2 to 2 cm facilitate particularly sharp optical imaging of the surface of the capture device, which may have a positive effect on the evaluation or analysis quality of the particle composition in the gaseous sample.

It is preferable within the meaning of the invention for the reference spectra, to which the spectra determined by the sensor devices are compared, to describe various forms of silicon dioxide. The various forms of the silicon dioxide preferably are, in particular, the various crystal modifications of silicon dioxide, for example quartz, cristobalite or tridymite, and the form of existence of silicon dioxide as amorphous silicon dioxide. Within the meaning of the invention, it is very particularly preferred for a content of fine quartz dust in a gaseous sample, in particular, to be able to be determined using the proposed invention. This is particularly relevant, in particular, because the “quartz” silicon dioxide crystal modification is classified as particularly hazardous to health. To determine the content of fine quartz dust in the respiratory air of a user, it is possible, for the purposes of the comparison with the spectra determined by the sensor device, to in particular use reference spectra that describe the optical behavior of quartz. The evaluation of the spectra recorded by the sensor device may for example consist of the recorded spectra being compared to silicon dioxide reference spectra. By way of example, it is possible to examine correlations between the spectra or determine and/or compare the relative and absolute position of peaks in the spectra. Within the meaning of the invention, it may moreover be preferable for machine learning methods to be used to compare the spectra determined by the sensor device with possible reference spectra. Preferably, the reference spectra are able to describe not only silicon dioxide and its various forms of existence but also other substances or materials which may occur as particles in gas samples or in the respiratory air of a user.

In a second aspect, the invention provides a method for analyzing a gaseous sample in respect of a composition of the particles contained in the sample, the method being characterized by the following method steps:
a) sucking in the gaseous sample using a sucking-in device,
b) separating the particles contained in the gaseous sample on the basis of a diameter of the particles using a device for separating the particles,
c) collecting the particles using a device for collecting the particles,
d) analyzing the particles contained in the gaseous sample on the basis of the diameter of the particles using a sensor device, the sensor device operating on the basis of Raman scattering,
e) producing spectra by way of the sensor device,
f) evaluating the spectra by virtue of the spectra being compared with reference spectra by means of a device for evaluation purposes.

Collecting the particles can also be referred to as capture within the meaning of the invention. In particular, this is implemented using a collection or capture device. The definitions, technical effects and advantages described for the proposed measuring device apply analogously to the proposed analysis method.

It is preferable within the meaning of the invention for the method steps to be carried out using devices that are constituent parts of the measuring device. In particular, this may be a proposed device according to the present invention. Expressed differently, the proposed analysis method can be carried out using a device according to the present invention. However, it may also be preferable within the meaning of the invention for the method to be carried out using a different device or for the devices required to carry out the method not to form a common device together.

It is preferable within the meaning of the invention for the comparison between the spectra and the reference spectra to be implemented by way of correlation, machine learning or a peak search.

A sensor device operating on the basis of Raman scattering (“Raman spectrometer”) is used in the present invention. This Raman spectrometer represents a third aspect of the present invention. In conventional spectrometry methods, a broadband excitation and gaps in the returned light are frequently used to identify resonant frequencies of substances and materials. However, the resonances of the forms that silicon dioxide exists in are at very long wavelengths, that is to say in a range of 15-25 μm, and so it represents a technical challenge to excite and/or register these. The inventors have therefore recognized that Raman scattering renders possible an excitation in the resonant range of the silicon dioxide at any wavelength. Consequently, the use of Raman scattering allows the technical realization of the proposed device and of the proposed method to advantageously be much simplified. In the context of the present invention, there is illumination using substantially monochromatic light in particular, with a high resolution and high accuracy of wavelength and intensity being sought after.

The sensor device of the invention can preferably be referred to as a spectrometer. The spectrometer structure can preferably comprise an illumination apparatus, a filter, a slit, a dispersive element, an imaging optical unit and/or an optical sensor. Within the meaning of the invention, the optical sensor can preferably also be referred to as image sensor. The filter can preferably be a notch filter, by means of which it is possible to filter frequencies lying within a tight frequency range out of a spectrum. The notch filter can preferably be an optical notch filter. Moreover, a bandpass filter for reducing a bandwidth of the excitation and a particle filter may be provided between the illumination apparatus and the slit.

It is preferable within the meaning of the invention for the particles from the gas sample to be deposited on the capture device. The particles that have been deposited on the surface of the capture device are illuminated by the illumination apparatus in order to excite the particles. It is preferable within the meaning of the invention for the illumination or the excitation of the particles on the surface of the capture device to have a bandwidth that is as small as possible. The bandwidth is preferably of the order of 1 nm or less. At the same time, the illumination apparatus is preferably configured to provide very high luminous fluxes. Moreover, the illumination apparatus is configured to ensure a particularly homogeneous and uniform illumination or excitation of the particles on the surface of the capture device, that is to say filter region to be measured. By way of example, the illumination apparatus may comprise high power light-emitting diodes (LEDs) or may be in the form of a line laser. By way of example, the diodes may have a radiant power of 5 to 10 W. Typical exposure times may be of the order of a few seconds.

It is particularly preferred within the meaning of the invention for high power light-emitting diodes to be used as an illumination apparatus, with these high power light-emitting diodes possibly being followed by a downstream bandpass filter in order to obtain a bandwidth of the excitation that is as small as possible.

It is preferable within the meaning of the invention for a filter to be subsequently able to be used to filter the excitation radiation out of the reflected or passed radiation. A notch filter can preferably be used to this end. It is a particularly preferred within the meaning of this invention for unwanted Rayleigh and Tyndall radiation to be filtered out of the spectrum using the filter, with the Rayleigh and Tyndall radiation being undesired predominantly because their usually high intensity may swamp the optical sensor and prevent an evaluation of the desired Raman radiation. The use of a notch filter was found to be advantageous because this can be used in particular to filter the elastically scattered Rayleigh and Tyndall radiation out of the spectrum while the non-elastically scattered Raman radiation is passed. However, the use of such a filter is optional. Instead, it is also possible to exploit the fact that the Rayleigh and Tyndall radiations are directed radiation while Raman radiation is undirected. It is preferable within the meaning of the invention for the unwanted Rayleigh and Tyndall radiation also to be able to be eliminated by way of a skillful arrangement of the optical components of the proposed Raman spectrometer. To this end, the slit, the dispersive element, the imaging optical unit and/or the optical sensor can be arranged at an angle to the optical axis of the illumination apparatus. It is preferable within the meaning of the invention for the notch filter to be disposed in the beam path downstream of the radiated filter. However, the notch filter may also be present arranged upstream of the optical unit or upstream of the image sensor.

It is preferable within the meaning of the invention for the slit to be configured to delimit the region of the filter detected by the downstream optical unit. The width of said slit is preferably chosen so that unwanted diffraction effects, which may occur if the slit is too narrow, are avoided. The width of the slit is preferably designed for the desired resolution, with a slit chosen to be too large possibly having a disadvantageous effect on the spectral resolution. The width of the slit preferably represents a compromise between a slit width that is too large and a slit width that is too small. It is preferable within the meaning of the invention that the slit width is selected on the basis of the resolution and/or the bandwidth of the spectrometer. By way of example, the slit width can be of the order of 200 μm. However, other values for the slit width are naturally also possible.

It is preferable within the meaning of the invention for the dispersive element to be in the form of a diffraction grating. The dispersive element is preferably configured to split the light reflected by the filter on the basis of its wavelength. As a result, it is possible to identify the wavelength ranges, relevant for the evaluation of the health protection. In this case, this preferably relates to those wavelengths or wavelength ranges that relate to the various forms of existence of the silicon dioxide. The diffraction grating can be designed as a transmissive blazed grating for example. By using such a blazed grating, it is possible to achieve a particularly compact structure of the proposed measuring device or spectrometer since the constituent parts of the device may be arranged in one line. However, alternatively use could also be made of prisms or reflective diffraction gratings as dispersive elements within the proposed sensor device. It is particularly preferred within the meaning of the invention for the dispersion to be implemented substantially at right angles to the slit since this allows optimal use of the sensor surface.

Subsequently, an optical unit for imaging the wavelength regions onto the optical sensor may be provided downstream of the dispersive element. Within the meaning of the invention, this optical unit is preferably also referred to as imaging optical unit. The imaging optical unit is preferably chosen in such a way that it ensures a sufficient resolution even for the smallest particles possible. By way of example, the smallest particles possible may have a diameter ranging from 0.4 to 1.0 μm.

The optical sensor is preferably configured to record the imaged spectra. It is preferably chosen in such a way that it has a sufficient pixel resolution and intensity resolution for the particles to be analyzed, in particular the silicon dioxide particles, and for the Raman scattering.

Subsequently, the spectra determined by means of the sensor apparatus can be evaluated and/or analyzed using the apparatus for evaluating the spectra. To this end, the elements or features indicating silicon dioxide particles in the various forms of existence of silicon dioxide, in particular, are identified in the spectra. In particular, the silicon dioxide spectra are recognized in this method step. Even though the use of an evaluation device for evaluating the spectra with the assistance of information technology is preferred within the context of the present invention, the spectra may also be evaluated by hand.

The determined results can be displayed on the device. To this end, the device may comprise display means, such as a display or a small visual display unit. The output of an optical, acoustic or haptic warning for the user may also be provided within the meaning of the invention should high particle numbers or an unwanted high proportion of quartz, for example, be detected among the particles. The invention can advantageously facilitate substantially continuous monitoring of the respiratory or ambient air of a user. In particular, a fine quartz dust exposure of the user can be monitored substantially continuously. In particular, the invention allows the user to inform themselves accurately about the air surrounding them and their exposure to dust or quartz. As a result, the user can adapt their work times accordingly, with the use of the invention advantageously rendering it possible to avoid work being interrupted “on suspicion” because the dust or quartz exposure may be too high.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them to produce useful further combinations.

Identical and similar components are denoted by the same reference signs in the figures, in which:

FIG. 1 shows a schematic representation of the structure of a preferred embodiment of the proposed device

FIG. 2 shows a schematic representation of the structure of a preferred embodiment of the sensor device of the proposed device

### DETAILED DESCRIPTION

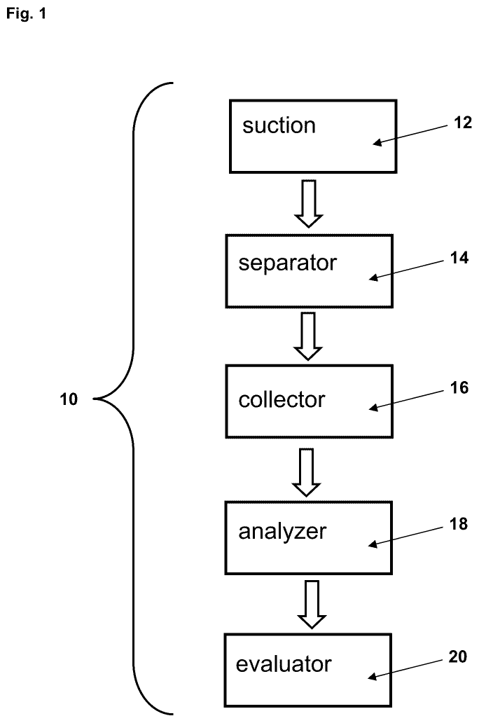

FIG. 1 shows a schematic representation of the structure of a preferred embodiment of the device 10. In particular, FIG. 1 shows the components of the measuring device 10, specifically a device 12 for sucking in the gaseous sample, a device 14 for separating the particles contained in the gaseous sample on the basis of a diameter of the particles, a device 16 for collecting the particles, a sensor device 18 for analyzing the particles contained in the gaseous sample and a device 20 for evaluating spectra.

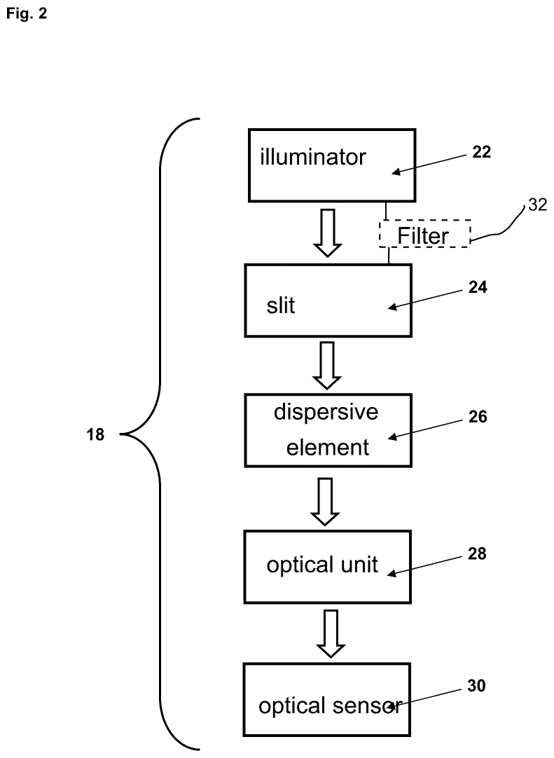

FIG. 2 shows a schematic representation of the structure of a preferred embodiment of the sensor device 18 of the proposed device 10. In particular, FIG. 2 shows the components of the proposed Raman spectrometer 18, specifically an illumination apparatus 22, a slit 24, a dispersive element 26, and imaging optical unit 28 and an optical sensor 30. The sensor device 18 may moreover comprise a filter 32, which is arranged between the illumination apparatus 22 and the slit 24. By way of example, the filter 32 may be designed as a particle filter. In particular, the filter 32 can be used to filter out unwanted constituents, such as Rayleigh and Tyndall radiation, from the radiation. Moreover, a band pass filter (without reference sign) for ensuring a bandwidth of the illumination that is as small as possible may be provided downstream of the illumination apparatus 22.

### LIST OF REFERENCE SIGNS

10 Device for analyzing a gaseous sample
12 Device for sucking in the gaseous sample, sucking-in device
14 Device for separating the particles contained in the gaseous sample
16 Device for collecting the particles
18 Sensor device for analyzing the particles, Raman spectrometer
20 Device for evaluating the spectra
22 Illumination apparatus
24 Slit
26 Dispersive element
28 Imaging optical unit
30 Optical sensor
32 Filter of the sensor device

1-14. (canceled)

15. A device for analyzing a gaseous sample in respect of a composition of the particles contained in the sample, the device comprising:
a) a suction for sucking in the gaseous sample;
b) a separator for separating the particles contained in the gaseous sample on the basis of a diameter of the particles;
c) a collector for collecting the particles;
d) a sensor for analyzing the particles contained in the gaseous sample on the basis of the diameter of the particles, the sensor operating on the basis of Raman scattering and being configured to produce spectral and
e) an evaluator for evaluating the spectra by virtue of the spectra being compared with reference spectra.

16. The device as recited in claim 15 wherein the suction includes a fan or a pump.

17. The device as recited in claim 15 wherein the suction is configured to convey a gas volume of 8-10 l/min.

18. The device as recited in claim 15 wherein the separator is configured to separate the particles according to an aerodynamic diameter, the separator being in the form of an inertial separator or cyclone separator.

19. The device as recited in claim 15 wherein the separator is configured to separate the particles according to their geometric diameter, the separator for separating the particles being in the form of a filter.

20. The device as recited in claim 15 wherein the collector is in the form of a filter.

21. The device as recited in claim 15 wherein the sensor for analyzing the particles is arranged at a distance d from the device for collecting the particles, the distance d being in a range from 1 to 50 mm.

22. The device as recited in claim 21 wherein the distance d is in a range from 2 to 20 mm.

23. The device as recited in claim 15 wherein the reference spectra describe different forms of silicon dioxide.

24. The device as recited in claim 15 wherein the device is in the form of a body-worn device for a user.

25. A method for analyzing a gaseous sample in respect of a composition of the particles contained in the sample, the method comprising the steps of:
a) sucking in the gaseous sample using a suction;
b) separating the particles contained in the gaseous sample on the basis of a diameter of the particles using a separator for separating the particles;
c) collecting the particles using a collector for collecting the particles;
d) analyzing the particles contained in the gaseous sample on the basis of the diameter of the particles using a sensor, the sensor operating on the basis of Raman scattering;
e) producing spectra by way of the sensor; and
f) evaluating the spectra by virtue of the spectra being compared with reference spectra via an evaluator for evaluation purposes.

26. The method as recited in claim 25 wherein the comparison between the spectra and the reference spectra is implemented by way of correlation, machine learning or a peak search.

27. A sensor device for analyzing a gaseous sample in respect of a composition of the particles contained in the sample, the sensor comprising:
an illuminator;
a slit;
a dispersive element; and
an imaging optical unit or an optical sensor.

28. The sensor device as recited in claim 27 wherein the illuminator has a bandwidth of the order of 1 nm or less with, at the same time, luminous fluxes and homogeneous illumination.

29. The sensor device as recited in claim 27 further comprising a filter, the filter being in the form of a notch filter.
